(19) United States
(12) Patent Application Publication
(10) Pub. No.: US 2011/0201474 A1
(43) Pub. Date: Aug. 18, 2011

(54) ARRANGEMENT FOR MOUNTING AND ATTACHING A PLANETARY GEAR TO A CAMSHAFT AND METHOD FOR MOUNTING THE PLANETARY GEAR

(75) Inventors: Frank Richter, Oberteuringen (DE); Ewald Schmitz, Daisendorf (DE); Jochen Walliser, Friedrichshafen (DE)

(73) Assignee: ZF FRIEDRICHSHAFEN AG, Friedrichshafen (DE)

(21) Appl. No.: 13/063,775

(22) PCT Filed: Sep. 30, 2009
(86) PCT No.: PCT/EP2009/062668

§ 371 Date: Mar. 14, 2011

(30) Foreign Application Priority Data
Oct. 30, 2008 (DE) 10 2008 043 337.3

(51) Int. Cl. F16H 57/08; B23P 17/00

(52) U.S. Cl. 475/331; 29/893.2

(57) ABSTRACT

An arrangement for mounting and fixing a planetary gear system (3) onto a camshaft (2). The planetary gear system comprises a planetary carrier (5) that forms the drive input of the camshaft (2), with planetary gears (7) mounted on planetary bolts (6). A ring gear (10) is rotationally fixedly connected to the camshaft (2), and a sun gear (8) is connected with a sun shaft (9). The ring gear (10) is arranged at the end of and coaxially with the camshaft (2) and is rotationally fixedly connected to the camshaft (2) by eccentrically arranged fixing elements (4).

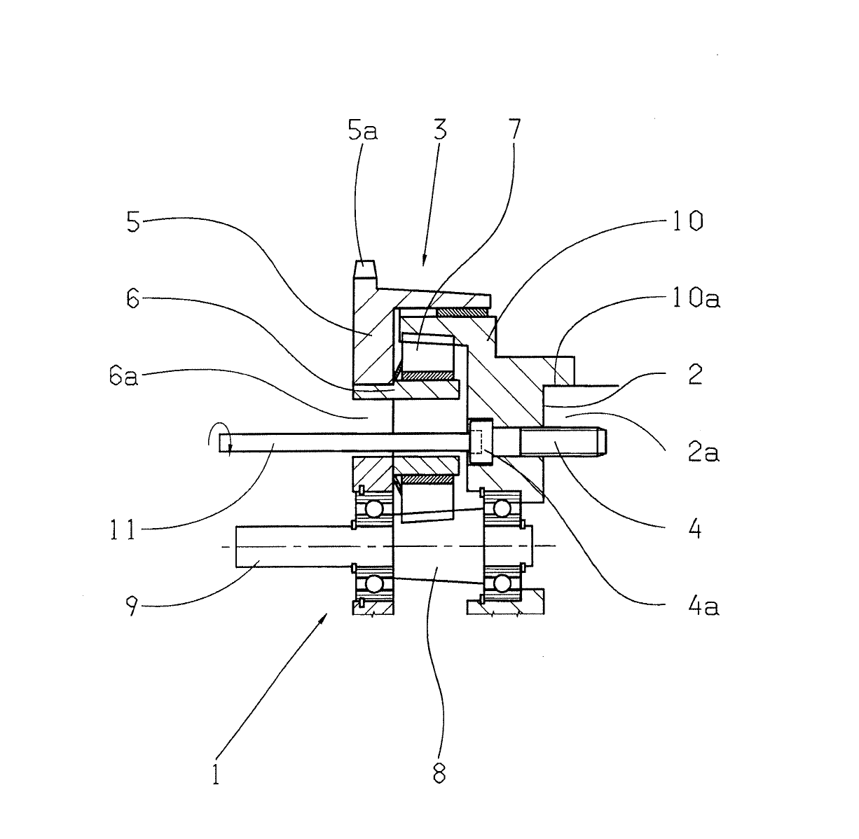

This application is a National Stage completion of PCT/EP2009/062668 filed Sep. 30, 2009, which claims priority from German patent application serial no. 10 2008 043 337.3 filed Oct. 30, 2008.

### FIELD OF THE INVENTION

The invention concerns an arrangement for mounting a planetary gear system, and a method for fitting a planetary gear.

### BACKGROUND OF THE INVENTION

Planetary gear systems are used for the driving and adjustment of camshafts and, for that purpose, are fixed onto the front of the camshaft of an internal combustion engine.

A camshaft adjustment device is known, from WO 2006/018254 A1, which comprises a planetary gear system by means of which a camshaft can be driven and its rotation angle can be adjusted. The planetary gear system comprises a planetary carrier with planetary gears which mesh with a sun and a ring gear. The planetary gear system is driven via its planetary carrier and drives the ring gear, which is connected rotationally fixed to the camshaft. The camshaft is adjusted by means of the sun gear.

It is known to connect planetary gear systems to the camshaft by means of a central bolt. This has the disadvantage that the center of the planetary gear system, especially with gear ratios i>7, is covered by the sun gear geometry, i.e., it is not accessible. If the sun gear or the sun shaft were to be made hollow, then although this would allow accessibility to the central bolt for fitting purposes, such a solution would always entail a loss of power density and would require more structural fitting space.

### SUMMARY OF THE INVENTION

The purpose of the present invention is to provide an arrangement for mounting and fixing, as mentioned at the start, which enables high power density and requires little fitting space for the planetary gear system and the camshaft adjustment device. A further purpose of the invention is to propose a simple method for fitting the planetary gear system.

Thanks to the eccentrically arranged fixing elements, in particular cylindrical bolts, the sun gear and the sun gear shaft can be designed and configured so as to optimize the fitting space required. Since there is no central fixing—as in the prior art—there is no need for a hollow sun shaft. By means of the axis-parallel extending fixing bolts, the ring gear and thus the entire planetary gear system are fixed at the front of the camshaft.

In an advantageous design, the ring gear is centered relative to the camshaft by a centering seating. This gives a coaxial arrangement of the planetary gear system and the camshaft. Advantageously, the said centering seating on the ring gear can be in the form of a centering bore, which holds the front end of the camshaft.

In a particularly preferred embodiment, the planetary bolts are hollow and the fixing elements are aligned with the planetary bolts. This gives the advantage that the fixing elements are accessible for assembly and fixing through the hollow spaces in the planetary bolts, preferably by means of a socket spanner for fixing the cylindrical bolts.

The planetary gear system is first ready assembled and set as a structural unit, onto the end of the camshaft, so that centering occurs at the same time. During or after this the fixing elements, in particular cylindrical bolts, are orientated in the circumferential direction aligned with the hollow planetary bolts. By means of a suitable fitting tool introduced from outside through the planetary bolts, the fixing elements can be fitted so that the ring gear, and thus the entire planetary gear system, are firmly connected to the camshaft. It is advantageous in the method, according to the invention, that the planetary gear system can be pre-assembled as a structural unit since this saves assembly time. A further advantage is that no sensitive gearteeth can be damaged by the fitting tool.

### BRIEF DESCRIPTION OF THE DRAWINGS

An example embodiment of the invention is illustrated in the drawing and will be described below, in more detail, whereby further features and/or advantages can be seen from the description and/or the drawing.

### DETAILED DESCRIPTION OF THE PREFERRED EMBODIMENTS

The single figure shows a view of a camshaft adjustment device 1. Of the camshaft 2 itself, only the front end 2a of the shaft is shown, on which a planetary gear system 3 is fixed by means of fixing elements in the form of cylindrical bolts 4. The planetary gear system 3 comprises a planetary carrier 5 with planetary bolts 6 on which planetary gears 7 (preferably three distributed around the circumference) are mounted. The planetary gears 7 mesh with a sun gear 8 made integrally with a sun shaft 9, and with a ring gear 10. The latter has a centering piece with a centering bore 10a in which the shaft end 2a of the camshaft 2 is held and centered. The ring gear 10 is held tight on the front shaft end 2a by the cylindrical bolts 4 and is, therefore, rotationally fixed to it. The planetary bolt 6 shown—like the other planetary bolts (not shown) arranged around the circumference—is made hollow, i.e., it has an axially through-going cylindrical hollow space 6a. The cylindrical bolt 4 shown—like the other cylindrical bolts (not shown)—is arranged approximately in line with the hollow space 6a so that the bolt head 4a, of the cylindrical bolt 4, is accessible by a fitting tool 11 inserted through the hollow space 6a. Thus, the number and arrangement of cylindrical bolts corresponds to the number and position of the hollow planetary bolts 6a so that they are accessible by the fitting tool 11.

The function of the camshaft adjustment device 1 is known, inter alia, from the prior art mentioned earlier. In relation to the example embodiment shown in the drawing, let it only be said that the drive input occurs via the planetary carrier 5 which, for that purpose, is in the form of a chain wheel with the corresponding teeth 5a. The drive output of the planetary gear system 3 occurs via the ring gear 10 to the camshaft 2. The camshaft 2 is adjusted by means of a positioning element (not shown) via the sun shaft 9 and the sun gear 8.

In a first step of the method, the planetary gear system 3 is fitted onto the camshaft 2 by first assembling the planetary gear system 3 as a structural unit. In the next step, the ready-assembled planetary gear system 3 is fitted onto the shaft end 2a of the camshaft 2, so that it is centered relative to the camshaft 2 by the centering bore 10a. Then, the planetary bolts 6 are orientated, in the circumferential direction, so that they are aligned with the cylindrical bolts 4 and the fitting tool 11 can then be introduced, from outside through the hollow space 6a of the planetary bolts 6, and fitted onto the bolt heads 4a. Depending on the cylindrical bolt 4, the fitting tool 11 is in the form of a socket spanner or an Allen key. Once the bolts 4 have been tightened, the planetary gear system 3 is connected firmly to the camshaft 2.

### INDEXES

1 Camshaft adjustment device
2 Camshaft
2a Front end of the shaft
3 Planetary gear system
4 Cylindrical bolt
4a Bolt head
5 Planetary carrier
5a Teeth
6 Planetary bolts
6a Hollow space
7 Planetary gear
8 Sun gear
9 Sun shaft
10 Ring gear
10a Centering bore
11 Fitting tool

1-8. (canceled)

9. An arrangement for mounting and fixing a planetary gear system (3) onto a camshaft (2), the planetary gear system comprising:
a planetary carrier (5) being designed as the drive input of the camshaft (2) with planetary gears (7) mounted on planetary bolts (6),
a ring gear (10) being rotationally fixedly connected to the camshaft (2), and
a sun gear (8) with a sun shaft (9),
wherein the ring gear (10) is arranged at the front of and coaxially with the camshaft (2) and is rotationally fixedly connected to the camshaft (2) by eccentrically arranged fixing elements (4).

10. The arrangement according to claim 9, wherein the ring gear (10) is centered relative to the camshaft (2, 2a) by a centering seating (10a).

11. The arrangement according to claim 9, wherein the planetary bolts are hollow with a cylindrical hollow space (6a), and the fixing elements (4) are arranged in an area of an axial extension of the hollow space (6a) in the ring gear (10).

12. The arrangement according to claims 9, wherein the fixing elements are in the form of cylindrical bolts (4) which are accessible through a hollow space (6a) of at least one of the planetary bolts (6).

13. The arrangement according to claim 9, wherein the sun gear (8) and the sun shaft (9) are integral with one another as a solid component.

14. The arrangement according to claim 10, wherein the centering seating is in the form of a centering bore (10a) in the ring gear (10) which retains the shaft end (2a) of the camshaft (2).

15. A method of fitting a planetary gear system onto a camshaft (2) in which the planetary gear system comprises a planetary carrier (5) designed as the drive input of the camshaft (2) with planetary gears (7) mounted on planetary bolts (6), a ring gear (10) rotationally fixedly connected to the camshaft (2), and a sun gear (8) with a sun shaft (9), the ring gear (10) is arranged at the front of and coaxially with the camshaft (2) and is rotationally fixedly connected to the camshaft (2) by eccentrically arranged fixing elements (4), the method comprising the steps of:
first assembling the planetary gear system (3) as an assembly, and
then fitting and centering the assembly at the front end of the camshaft (2, 2a).

16. The method according to claim 15, further comprising the step of orientating the fixing elements, in particular cylindrical bolts (4), in a circumferential direction in line with the hollow planetary bolts (6), and then introducing a fitting tool (11) through a hollow space of the planetary bolts (6) for securing the fixing elements.

17. The method according to claim 16, further comprising the step of using as cylindrical bolts (4) as the fixing elements.
